(19) United States
(12) Patent Application Publication
(10) Pub. No.: US 2004/0145086 A1
(43) Pub. Date: Jul. 29, 2004

(54) Injection molding method

(76) Inventor: Atsushi Yusa, Toride-shi (JP)

Correspondence Address: Oliff & Berridge, P O Box 19928, Alexandria, VA, 22320, US

(21) Appl. No.: 10/478,415

(22) PCT Filed: May 21, 2002
(86) PCT No.: PCT/JP02/04869

(30) Foreign Application Priority Data
May 22, 2001 (JP) 2001-151796

(51) Int. Cl. B29C 45/00

(52) U.S. Cl. 264/328.11; 264/328.17; 264/328.16

(57) ABSTRACT

An injection molding method that ensures, in the molding of optical disks and the like, accurate transferability, optical characteristics and mechanical characteristics for accurately transferring a super fine structure that could not be transferred satisfactorily by the conventional molding method, mass production of replicas, and so on, thus improving the production efficiency. It comprises the steps of using a cavity forming mold composed of at least two members, charging molten resin into the mold, obtaining a molding, wherein one of the members constituting the mold passes through a stage that is separated into at least three steps, a charging step, a press step and a molding take-out step, and molten resin is charged into the unclosed cavity of the one member in the charging step and then a molding is formed in the press step.

### FIELD OF THE INVENTION

The present invention relates to an injection molding method with superior transferability, optical characteristics and productivity.

### BACKGROUND ART

In injection molding of thermoplastics, a process is carried out repeatedly, in which a mold is placed in an injection molding machine, a resin that has been melted by heating is injected into the mold whose temperature is regulated to below the glass transition temperature of the used resin material, then pressure is applied through the clamping pressure of the molding machine, and after waiting until the resin has cooled down and hardened, the product is retrieved. In products in which a highly precise transfer of the mold of the sub-micron order is necessary, as in optical disks for example, it is necessary to control not only the transfer, but also the optical characteristics and the mechanical characteristics.

FIGS. 14 to 17 show a conventional molding method for optical disks, such as CDs and DVDs.

As shown in FIG. 14, a cavity (37) of a space that is filled with resin is formed by forming a fixed mold (30) attached to a fixed platen (32) and a movable mold (31) attached to a moving platen (33) of the molding machine. A polycarbonate with bisphenol A as the monomers is ordinarily used for the resin of the optical disk, and the glass transition temperature (Tg) is adjusted, for example through its molecular weight, to 130 to 150° C. A temperature adjustment circuit, which is not shown in the figures, is provided inside the two molds, and temperature adjustment water of about 80 to 130° C., which is lower than the glass transition temperature of the resin, is constantly sent through this temperature adjustment circuit. A stamper (7) made of Ni or the like and provided with pre-grooves or pre-pits, which are fine protrusions or depressions (40) with which signals can be recorded/reproduced with a laser, is attached to the surface of the fixed mold or the movable mold, and FIG. 14 shows an example in which it is attached to the fixed mold.

As shown in FIG. 15, the step of filling in the resin, is performed with a nozzle front end (34) in close contact to the fixed mold (30), which fills the resin that has been melted with a plasticizing cylinder (not shown in the drawings) of the molding machine through a spool (36) of the mold. In recent years, the thickness of optical disks such as DVDs, which is 0.6 mm, has become thinner than that of CDs for example, which is 1.2 mm, and the filling of the cavity (37) has become difficult, so that the cavity thickness is opened more than the thickness of the product during the filling, and the cylinder temperature, that is, the resin temperature is set to 360 to 390° C., which is higher than the 300 to 340° C. for CDs, thereby performing the filling with considerably lower viscosity.

Moreover, the molten resin fills the cavity while contacting the mold walls and solidifying, so that the more the filling proceeds, the more this solidified layer cools and grows. For this reason, the injection pressure, which is the pressure for the cylinder or the motor for advancing the screw, must be increased. Consequently, the internal pressure of the resin occurring during the injection filling increases.

Then, after the filing, the flow front (42) of the resin often does not reach the mold member (43) that is the cavity edge and that forms the outer diameter of the product. This is, because as mentioned above, the filling is performed while the cavity thickness T during the filling is opened wider than the product thickness t, and the cavity thickness is made thin by a compression through clamping after the filling, as will be explained later. However, with this method, a solidified layer is formed between the mold walls and the fluid resin during the filling, resulting in shearing forces, which become a cause for increased birefringence. Moreover, the growth of the solidified layer (the skin layer) at the inner circumference and the outer circumference is different, so that the this difference between inner and outer birefringence tends to become large. As methods for reducing it, there is for example setting a higher molding temperature or increasing the injection speed or the like, and these allow some control of the in-plane birefringence (which is correlated to the difference between the stress in a radial direction and the stress in a circumferential direction), but controlling the birefringence for components that are obliquely incident on the substrate is very difficult, because they are strongly susceptible to the photoelastic constant of the resin material. There is furthermore the approach of setting the mold temperature very high and baking the product at a high temperature that is close to the thermal deformation temperature, but there are limits. Another possibility is to lower the photoelastic constant of the resin material, but this has the disadvantage that it increases costs and lowers the sturdiness.

Moreover, in such conventional filling methods, the resin viscosity becomes higher and the transferability becomes poorer towards the outer circumference, because the temperature at the interface to the stamper (7) becomes lower, so that there is the problem that uniform transfer at the inner and the outer circumference is difficult to attain.

Furthermore, in order to ensure flowability, there are many restrictions regarding the resin material to be used. For example, if the molecular weight is increased in order to improve the product's sturdiness, then the Tg generally increases as well, and satisfactory flowing becomes impossible. Thus, this puts large restrictions on how thin the product's thickness can be made.

After the resin has been filled into the cavity in FIG. 15, the spool (36) is punched out with a cut punch (38) inside the mold by driving a molding machine piston (39), as shown in FIG. 16, thus forming the product's inner diameter (41). At the same time, the mold is clamped by increasing the clamping pressure on the molding machine side, thus attaining a transferability as shown in the detailed view of portion IV.

The solidified layer of the transfer surface that is in contact with the mold is detrimental, and it is necessary to increase the clamping force in order to attain sufficient transferability, so that increased damage of the stamper (7) and the occurrence of internal stress could not be avoided.

The eccentricity of the cut punch (38) with respect to the stamper (7) after the punching needs to be controlled to at least within 30 μm, but the temperature distribution of the fixed mold and the movable mold is worsened by an increase in mold temperature, and there is the problem that it is difficult to maintain the centering precision.

Furthermore, in recent years, optical disks with smaller diameters, for which MD minidisks are a typical example, have become standardized and brought to the market, and in the course of this, also the product's inner diameter has become small and there is a need to make the signal area as wide as possible. For this reason, it is necessary to make the outer diameter of the cut punch (38) small, and thus, since it is difficult to independently regulate the temperature of the cut punch (38), there is for example the obstacle that the solidifying speed of the spool (36) slows down. Moreover, it is desirable to make the product small and perform multi-cavity molding, but this is difficult to accomplish with optical disks due to the following obstacles. First, in order to realize multi-cavity molding, the spool portion needs to be heated to about 300° C., which is the ordinary melting temperature, and a mold of the hot-runner type, which is spool-less, is necessary. But in this case, there is a steep temperature gradient between the hot runner and the cavity, so that there are temperature irregularities between the cavities. Thus, the variations in transferability and machine characteristics become large. Furthermore, if the cut punch, corresponding to the cavity, is driven by a piston of one molding machine, then there are variations in the parallelism, and slight eccentricities become more problematic. Thus, it becomes impossible to attain a product with high density.

Next, as shown in FIG. 17, the product is retrieved from the stamper and the mold using air or the like. At this time, the shape of the pre-pits and pre-grooves at the signal surface of the substrate, in particular at the outer circumference, tends to become asymmetric, as shown in the detailed view of portion V. Possible factors responsible for this are that the amount of shrinkage to the inner circumferential side becomes larger toward the outer circumference, and that since the stamper is made of a metal material, its linear expansion coefficient is smaller than that of the resin material, so that its amount of shrinkage is also smaller.

Moreover, the damage on the stamper due to the internal pressure of the resin and the clamping force is large, and therefore it is difficult to change the material of the stamper to glass or the like, considering production durability. This is exacerbated by the fact that the solidification at the outer circumference is fast and the difference between the cooling speeds at the inside and the outside is large. Even if the extent of the deformation of the pre-grooves was very small at perhaps less than 10% of a groove depth d of 60 to 250 nm, nowadays, as the track pitch becomes narrower, the laser wavelength becomes shorter, the NA becomes higher, and the spot diameter on the substrate during recording and reproduction becomes smaller, it may result in groove noise, and is becoming a considerable problem. Moreover, as the outermost circumference contacts the mold member, which defines the outer diameter of the product, and is rapidly cooled and solidified, the above-described ripples are large at the core layer in the inner portion of the product, and tend to become funnel-shaped or wedge-shaped as shown in portion A in FIG. 17. These shape changes at the outer circumference portion are also referred to as “ski-jumps.”

Thus, in conventional injection molding methods, growth of a solidified layer during filling cannot be prevented, and there are differences in the viscosity and cooling speed at the filling start position and the filling end position, and for these reasons, there are limits as the demands for precision regarding transfer and optical characteristics become stricter, there are strict limitations regarding materials, and it was difficult to obtain high-quality products. Moreover, since filling and cooling are carried out within the same mold, when increasing the mold temperature in order to attain high transferability, then the cooling time must be prolonged in order to attain favorable mechanical properties, which leads to the problem that the production efficiency cannot be increased.

In order to solve these problems, molding methods have been proposed, in which the filling and the cooling step are separated by using a plurality of molds and presses (see JP H07-148772A and JP H05-124078A). With these methods, the heat capacity of the molds is large, and a long time of at least 1 min is needed for the annealing, so that many molds need to be prepared, which leads to high costs. Furthermore, these methods do not solve the fundamental problem that is intrinsic to injection molding, namely that the resin must flow through the spool or the like all the way to the cavity edge. In methods for manufacturing glass sheets, a molding method has been proposed, in which a glass blank that is placed in the mold is heated to at least the glass softening temperature, and then the mold is pressed, thus attaining a high shape precision (JP H11-92159A), but there is the problem that it takes time until the solidified blank is heated and melted.

On the other hand, supercritical fluids, which are in a peculiar intermediate state that is not quite fluid and not quite gaseous, have received attention, and JP H11-128722A proposes a new transfer method that utilizes the permeability of supercritical fluids. A supercritical fluid that is dissolved in an unreacted driver such as silica is brought into contact with a structure including a reaction initiating reagent, and the surface of that structure is coated with the reaction product. With this method, the surface structure and the replica that is the reaction product cannot be non-destructively separated, so that it is necessary to, for example, burn the structure in order to retrieve the replica. Thus, a replica of the structure can be obtained only once, so that it cannot be used industrially as a molding process. This is also the same in the method of bringing a supercritical fluid dissolved into a polymer material in contact with an inorganic porous film (JP H07-144121A).

Moreover, there are the following methods utilizing supercritical fluids for thermoplastic molding. Microcellular plastic having an unfoamed skin and tiny foamed cells inside have been researched at America's Massachusetts Institute of Technology (MIT), and patented with the basic U.S. Pat. No. 5,158,986 “Microcellular thermoplastic foamed with supercritical fluid.” In this technology, the supercritical fluid permeates through a plasticized thermoplastic resin, and by lowering the internal pressure of the mold after filling the mold, internal foaming is achieved. The purpose of this is clearly different than that of the present invention, which is to improve the transferability of fine structure.

Furthermore, it is known for example from J. Appl. Polym. Sci., Vol. 30, 2633 (1985) that when carbon dioxide is absorbed by a resin, it acts as a plasticizer for thermoplastic resins and lowers the glass transition point of resin, and JP 2001-62862A discloses a technique applying this to injection molding. Here, molten resin in which carbon dioxide (CO₂) has been dissolved is filled into and molded in a mold filled with pressurized CO₂, but the CO₂ is not necessarily a supercritical fluid. Due to the above-mentioned effect that the CO₂ acts as a plasticizer, the viscosity of the resin can be temporarily lowered, which improves the transferability, and contributes to improved mass-production properties compared to conventional molding methods, but the permeability of the supercritical fluid, which rivals that of gases, is not pro-actively utilized. Therefore, it is sufficient for transfers of the sub-micron order at aspect ratios of less than 1, which is the pattern level of optical disks substrates, but there are limits to the transfer at the nano-order level and of fine structures with high aspect ratios. The biggest reasons for this are that (1) in thermoplastic resins, the temperature of the material is increased and the properties of non-Newtonian fluids are taken advantage of to lower the viscosity by shear heat generation due to high-speed injection or the like, but there is a lower limit at about 100 poise, and (2) after filling the mold, the resin comes in contact with a mold that has been temperature-controlled to a very low temperature that is at least 100° C. lower than that of the resin temperature, so that the viscosity increases rapidly at the surface, and even if it is temporarily suppressed by the above-noted method or the like, there are limits to how low the viscosity can be lowered. Moreover, during high-speed filling, CO₂ is dissolved from the flow front, so that it remains dissolved within fine structures.

FIGS. 27 and 28 respectively illustrate the state when resin material (109) has been flowed onto the surface of a transfer object structure (103), such as a stamper, that is held in a support mold (110) and the state when the resin material is press-filled with the a mold (111). As shown in FIG. 28, by filling the resin material (109) into the structure (112), a replica of resin material can be achieved, but thermoplastic resin generally has a high melt viscosity, so that the transfer at the nano-order level or into super-high aspect structures is difficult. This seems to be due to the influence of residual air and surface tension when a polymer is filled into the fine structure.

In the present invention, the aspect ratio is defined as the ratio (D/W) or the maximal width W to the maximal depth D of the holes into which the resin is filled in the structure (112) to be transferred. As is shown in zone A in FIG. 29, when the width W of individual patterns is narrowed down to the nano-order, and the aspect ratio increases, it is more difficult to fill a series of closely adjacent patterns than a series of patterns that are spaced further apart as in zone B. Moreover, even when the fine structures are sufficiently filled, resin that has been taken into a structure with a high aspect order is difficult to pull out, and there is the problem of deformations during mold release, as shown in FIG. 30, so that a precise shape is difficult to attain.

It is an object of the present invention to solve the problems of these conventional injection molding methods, and to provide an injection molding method that achieves, precise transferability, optical characteristics, and mechanical characteristics, which allow accurate transfer of superfine structures for which a satisfactory transfer could not be accomplished with conventional molding methods, and moreover, the production efficiency can be improved, allowing the mass production of replica, for example.

### DISCLOSURE OF THE INVENTION

To attain these objects, in accordance with the present invention, in an injection molding method for obtaining a molded product, wherein a molten resin is filled into a mold that forms a cavity and that is constituted by at least two members, at least one member constituting the mold is moved through stages that are divided into at least three steps including a filling step, a pressing step and a molded product retrieving step, and the molded product is formed in the pressing step after the molten resin has been filled in the filling step into the cavity, which is not closed, of said one member.

It should be noted that in the present invention, “injection molding” is defined as a molding method in which a molded product is obtained by filling resin that has been plasticized and melted with a screw into a mold and solidifying the resin.

With the present invention, molten resin is not filled into a closed mold, so that solidified layers do not tend to occur at the mold wall during flowing, and a uniform melting state of the resin surface can be maintained on the side that is not in contact with the mold, so that the resin temperature during the filling can be lowered, and a high transferability can be attained, even when using a resin with high stiffness and poor flowability. Also when the filling proceeds, the internal resin pressure does not increase due to solidification of the resin, so that it is not necessary to increase the injection pressure in order to advance the screw.

In the injection molding method according to the present invention, the molten resin is filled within a vacuum into the cavity, which is not closed.

By performing the filling in a vacuum, voids and bubbles due to gas and air inside the resin do not appear at the resin surface after the filling. Moreover, since the product shape is attained by pressing and cooling after moving the moving mold to a separate cooling stage after the filling, it becomes possible to perform the transfer uniformly in a state in which the resin viscosity at the surface is low, and it is possible to perform the transfer at a pressure that is considerably lower than the clamping pressure that was necessary to attain transferability with conventional molding. Consequently, production is possible without limitation to metal materials with high durability for the mold members such as the stamper, which carries the information to be transferred.

Moreover, in the injection molding method of the present invention, the internal stress generated during pressing is low, so that the oblique incidence birefringence can be decreased even when using a resin material with a large photoelastic constant in which a large stress tends to occur. Moreover, since the temperature of the injected resin can be lowered, the temperature of the cooling stage can be set lower than the stage temperature of the injection step, so that the cooling time can be shortened, which improves the production efficiency.

In the injection molding method according to the present invention, the molded product is formed by the pressing step after at least one member constituting the mold is moved through the stages that are divided into at least three steps including the filling step, the pressing step and the molded product retrieving step, and the molten resin has been filled in the filling step into the cavity, which is not closed, of said one member, and a supercritical fluid of CO₂ gas has been permeated under pressure into that molten resin.

By including a supercritical fluid of CO₂ gas in the molten resin, the inherent properties of the viscous body of the resin are improved due the permeability of the supercritical fluid, and the wettability of the fine depressions and protrusions becomes better, allowing transfer of nano-order structures. Moreover, by controlling the internal pressure of the mold cavity to at least the pressure at which the CO₂ gas reaches its supercritical state, the fluid maintains its supercritical state until the resin material is completely solidified, so that foaming due to the gasification of the fluid can be prevented.

In the injection molding method according to the present invention, after the thermoplastic resin has solidified, the supercritical fluid is gasified by releasing the mold pressure, and a solidified product of thermoplastic resin is released from the mold by this gas pressure.

After the resin has been solidified in the above-described method, the supercritical fluid is gasified by releasing the mold pressure, and the gas pressure achieves mold release of the resin molded product from the super-fine structure of the mold, so that mold release is possible without damaging the shape precision of the replica onto which the shape of the fine structure has been accurately transferred.

In the injection molding method according to the present invention, it is preferable that said one member moves onto a stage that has been heated in the injection step to at least (Tg−20)° C., wherein Tg is the glass transition temperature of the used resin material, and moves onto a stage that has been heated to not more than (Tg+100)° C. in the pressing step.

By setting the temperature of the stage in the injection step to at least (Tg−20)° C., viscosity increases of the resin, during the filling can be controlled, and by setting the temperature of the stage in the pressing step to not more than (Tg+100)° C., the cooling efficiency can be improved.

Moreover, it is preferable that the minimum mold thickness from the two heating stages to the cavity is at least 10 mm. Thus, the cooling of the surface contacting the mold during the injection can be inhibited and the cooling of the product during the pressing step can be expedited, so that the mass-production efficiency can be improved without worsening the product quality.

In the injection molding method according to the present invention, it is preferable that the shape of the nozzle front end in the injection step can be changed as suitable for the shape of the product. Moreover, it is preferable that the shape of this nozzle front end forms a shape that is close to the moving mold and to the cavity. Thus, even when the product shape is complicated or the shape is large, the resin surface temperature after the filling can be made uniform across the entire surface, so that a uniform and favorable transfer can be achieved.

In the injection molding method according to the present invention, it is preferable that when filling the thermoplastic resin into the mold and at the start of pressing, the mold temperature is set to at least the glass transition temperature Tg of the thermoplastic resin, and during the pressing, the mold temperature is made lower than Tg to cause solidification.

Thus, an increase in viscosity of the resin surface due to contact of the molten resin with the mold can be inhibited, so that the permeation into the fine structures can be carried out effectively. Moreover, by lowering the mold temperature during the pressing, the cooling time can be shortened.

### BRIEF DESCRIPTION OF THE DRAWINGS

FIG. 1 is a diagram showing the overall conventional of an injection molding apparatus according the present invention, taken from above.

FIG. 2 is a cross-sectional diagram of the essential portions of the injection step portion in the injection molding apparatus of the present invention, schematically showing the state at the beginning of the plasticization.

FIG. 3 is a cross-sectional diagram of the essential portions of the injection step portion in the injection molding apparatus of the present invention, schematically showing the state at the end of the plasticization.

FIG. 4 is a cross-sectional diagram of the essential portions of the injection step portion in the injection molding apparatus of the present invention, schematically showing the state during the injection filling.

FIG. 5 is a cross-sectional diagram of the essential portions of the pressing step portion in the injection molding apparatus of the present invention, schematically showing the state before the pressing.

FIG. 6 is a cross-sectional diagram of the essential portions of the pressing step portion in the injection molding apparatus of the present invention, schematically showing the state during the pressing and showing illustrating the transfer of the stamper.

FIG. 7 is a cross-sectional diagram of the essential portions of the pressing step portion in the injection molding apparatus of the present invention, schematically showing the state during the press releasing.

FIG. 8 is a cross-sectional diagram of the essential portions of the retrieving step portion in the injection molding apparatus of the present invention, schematically showing the state during the retrieving step and the transfer step of the substrate surface.

FIG. 9 is a cross-sectional diagram of the essential portions of the nozzle front end portion in an injection molding apparatus of the present invention, schematically showing the state during the plasticization measurement.

FIG. 10 is a cross-sectional diagram of the essential portions of the nozzle front end portion in an injection molding apparatus of the present invention, schematically showing the state during the injection filling.

FIG. 11 is a time chart of the injection molding cycle in this working example.

FIG. 12 shows the results of measuring the perpendicular incident retardation of an optical disk substrate according to this working example.

FIG. 13 shows the results of measuring the cross-sectional birefringence of an optical disk substrate according to this working example.

FIG. 14 is a cross-sectional diagram of the essential portions of a conventional injection molding apparatus, showing the state before injection.

FIG. 15 is a cross-sectional diagram of the essential portions of a conventional injection molding apparatus, showing the state during injection.

FIG. 16 is a cross-sectional diagram of the essential portions of a conventional injection molding apparatus, showing the state during clamping and the transfer state of the stamper.

FIG. 17 is a cross-sectional diagram of the essential portions of a conventional injection molding apparatus, schematically showing the state during mold release and the transfer state of the substrate surface.

FIG. 18 is a time chart of the injection molding cycle in a comparative example.

FIG. 19 shows the results of measuring the perpendicular incident retardation of an optical disk substrate according to a comparative example.

FIG. 20 shows the results of measuring the cross-sectional birefringence of an optical disk substrate according to a comparative example.

FIG. 21 is a diagram showing the filling step in a molding process that uses a thermoplastic resin according the present invention.

FIG. 22 is a diagram showing the filling step in a molding process that uses a thermoplastic resin according the present invention.

FIG. 23 is a diagram showing the pressing step in a molding process that uses a thermoplastic resin according the present invention.

FIG. 24 is a diagram showing the pressing step in a molding process that uses a thermoplastic resin according the present invention.

FIG. 25 is a diagram showing the pressing step in a molding process that uses a thermoplastic resin according the present invention.

FIG. 26 is a diagram showing the pressing step in a molding process that uses a thermoplastic resin according the present invention.

FIG. 27 is a diagram showing the molding of a fine structure.

FIG. 28 is a diagram showing the molding of a fine structure.

FIG. 29 is a diagram showing the molding of a fine structure.

FIG. 30 is a diagram showing the state of a fine structure after mold release.

### BEST MODE FOR CARRYING OUT THE INVENTION

For the resin that is used in the injection molding method of the present invention, a resin is appropriate that can be reversibly changed between its fluid and its solidified state by heating and cooling, and even though there is no limitation to its type, a thermoplastic resin is used preferably.

Examples of thermoplastic resins include polyethylene, polystyrene, polyacetal, polycarbonate, polyphenylene oxide, polymethylpentene, polyethelimide, ABS resin, polymethylmethacrylate, and amorphous polyolefine.

With regard to obtaining a molded product with superior optical characteristics, a resin with superior transparency is desirable, and in particular polycarbonate, polymethylmethacrylate, and amorphous polyolefine are preferable.

Referring to the accompanying drawings, the following is a more detailed description of embodiments of the present invention. In these embodiments of the present invention, an injection molding method and an injection molding apparatus for manufacturing an optical disk are described as representative examples, but needless to say, the present invention can also be embodied by various other types of products and in various forms.

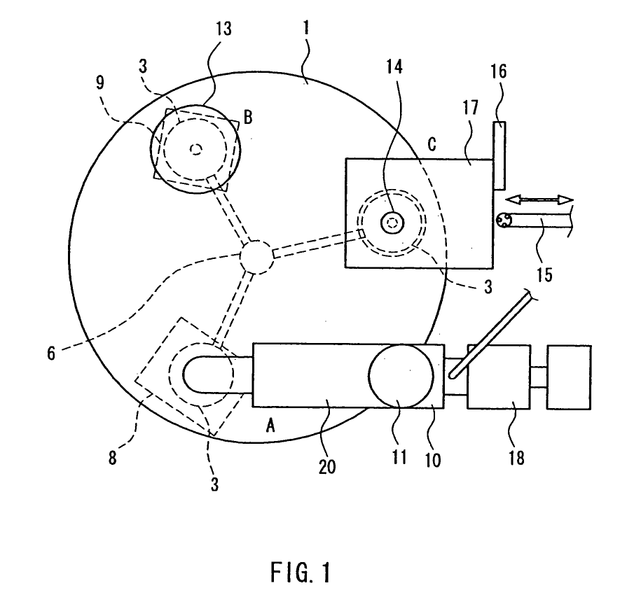

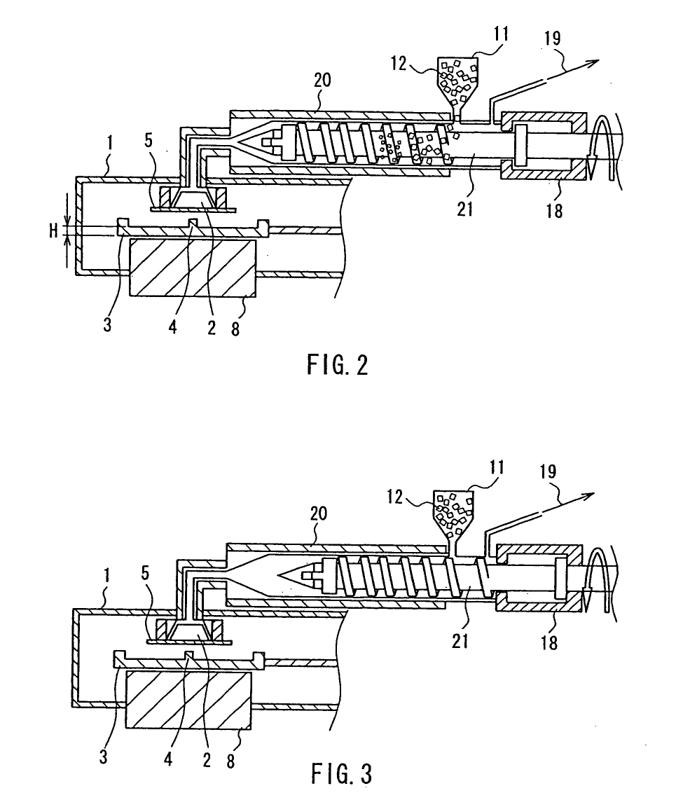

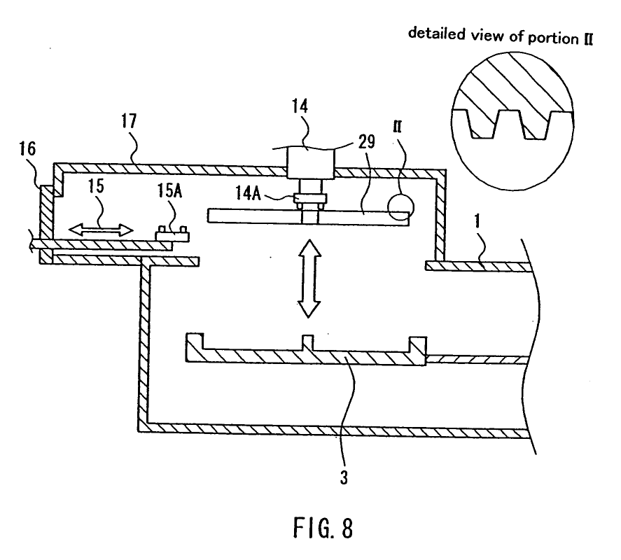

In the present embodiment, as shown in FIG. 1, an injection molding apparatus is used that performs three steps as the basic steps, namely an injection filling step A, a pressing step B and a retrieving step C. It is also possible to provide a plurality of each step, or to provide a step of heating the molds prior to the injection step. FIG. 1 is a diagram showing an injection molding apparatus according the present invention from above, and FIGS. 2 to 8 are schematic cross-sectional views of the portions for each step of the apparatus. FIGS. 2 to 4 illustrate the states from plasticization to filling in the injection step A, FIGS. 5 to 7 are diagrams of before and after the pressing during the pressing step C and the opening of the press. FIG. 8 is a diagram showing how the product is retrieved in the retrieving step C.

As shown in FIG. 1, moving molds (3) are rotatably moved through the various stages in a vacuum furnace (1) around a rotation shaft (6). First, in the injection step A, a plasticization device (10) applies pressure with a cylinder (18), thus performing the injection/filling of molten resin into the movable mold (3) on a heating plate (8). The vacuum furnace in the present invention is in a state of reduced pressure or vacuum in order to ensure that oxygen or the like from the air is not taken in by the surface of the molten resin, forming bubbles, but if the vacuum is too high, components with a low boiling point may volatilize from the inside of the resin and cause internal foaming, so that a vacuum degree in the range of 1×10⁻² Pa to 1×10³ Pa is desirable. After the injection is finished, the moving mold moves to the heating plate (9) in the pressing-cooling step B, and a press mechanism (13) provided above applies pressure to the moving mold, which is cooled while providing the product with a precise shape. Thus, the moving mold is in close contact with heating plates (8) and (9) that are individually temperature-controlled in the injection step and the pressing-cooling step.

The temperature of the heating plates can be chosen freely, but it is preferable that in the injection step A it is at least (Tg−20)° C., and in the pressing-cooling step B, it is not greater than (Tg+100)° C., where Tg is the glass transition temperature of the resin. It is also possible to improve production efficiency by providing a stage heating the molds prior to the injection step, by providing a plurality of stages for the cooling step, or by changing the temperature settings at each stage.

After the pressing, the moving mold (3) moves to the retrieving step C, and after a retrieving mechanism (14) has moved the product from the vacuum furnace (1) to a small vacuum furnace (17), a retrieving mechanism (15) advances into the small vacuum furnace (17) through a shutter (16), and the retrieving mechanism (15) retrieves the product from the retrieving mechanism (14) into the atmosphere. The moving mold (3) from which the product has been retrieved, moves again to the injection step A. Continuous production is possible by repeating these steps.

Next, these steps are explained in greater detail with reference to FIGS. 2 to 8, which are cross-sectional diagrams. As shown in FIG. 2, a screw (21) inside the plasticization device (10) is rotatively driven by a motor that is not shown in the drawings, and thus starts to supply pellets (12) of resin from a dry hopper (11). This mechanism is the same as in conventional molding machines. The movable molds (3) in the present embodiment are provided with a pin (4) for forming the inner diameter of the optical disk at the center of the molds, but the shape of the moving molds may be changed in accordance with the product shape, or a transfer object, such as a stamper (7) may be provided on the moving molds. As mentioned above, the cavity of the moving molds (3) is not closed while the molten resin is filled in, so that no solidified layer tends to form at the mold wall during the flowing. Furthermore, in order to improve the effectiveness of heat exchange, it is preferable that a material with a large thermal conductivity is used for the movable molds (3) and their thickness H is as thin as possible. More specifically, a thermal conductivity of at least 20 w/m•k (at 200° C.) and a thickness H of at least 15 mm are preferable.

Moreover, in this embodiment, the internal resin pressure at the screw front end increases during the plasticization measurement and to suppress resin leakage from the nozzle front end (2), a mechanical shutter (5) is provided, but any mechanism for suppressing resin leakage may be used. As in conventional molding methods, molten resin is measured in a region (22) inside a heating cylinder (20) by retracting the screw (21) to a measurement position, as shown in FIG. 3, which shows the state after the measurement is finished.

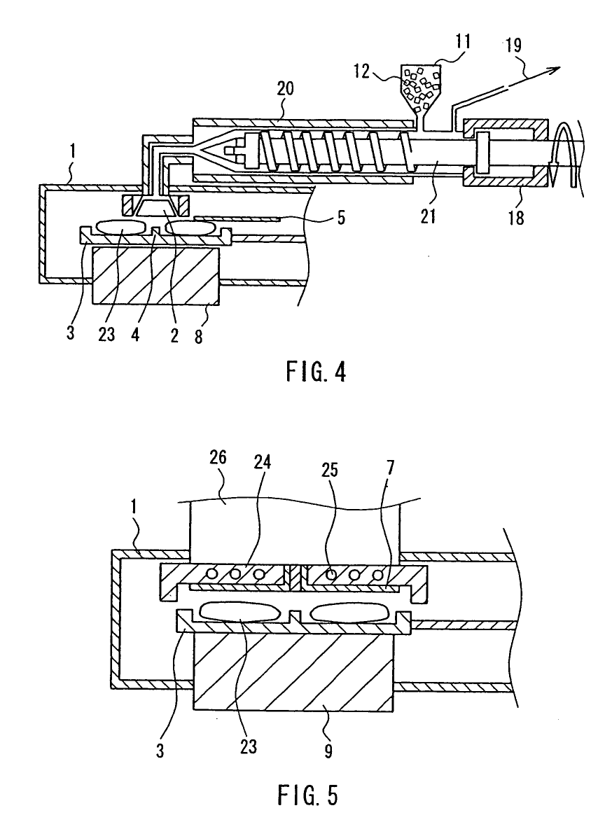

In this embodiment, a lot of volatile gases emanate from the molten resin, so that they are evacuated with a vacuum hole (19) positioned behind the hopper (11). In the molding method of the present invention, when there are large amounts of low molecular weight components and/or volatile components at the time of plasticization/melting, then foaming tends to occur in low pressure or vacuum atmospheres, so that it is preferable to evacuate these components. After the measurement is finished, the mechanical shutter (5) at the nozzle front end (2) is opened, and at the same time the screw (21) is advanced by the pressure in the cylinder (18) arranged behind the plasticization device, as shown in FIG. 4, so that the molten resin (23) is filled into the moving mold (3). The shape of the nozzle front end (2) in this embodiment of the present invention can be optimized in view of the mold shape, so that resin in a molten state that is close to the shape of the cavity is formed.

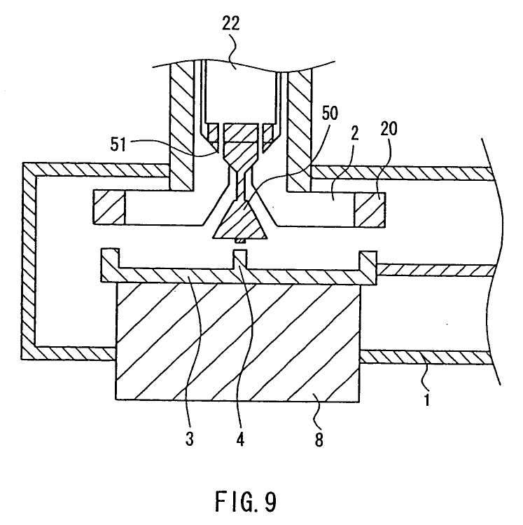

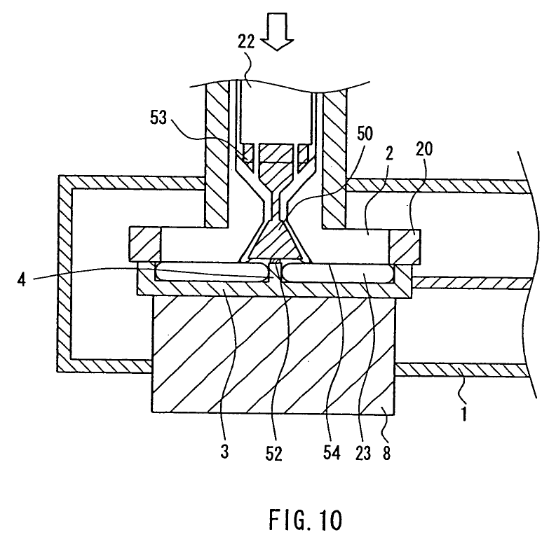

More specifically, another example of the shape of the nozzle front end (2) in the injection stage is explained with reference to FIG. 9 and FIG. 10. In FIG. 9, a sealing cone (50) is inserted in the nozzle front end (2). During the plasticization measurement, the internal pressure of the resin rises and leads to a pressure in downward direction in the figure, and molten resin does not leak from the nozzle, because it is closed in by a sealing cone receiving surface (51) where the nozzle front end (2) contacts the sealing cone (50) by lowering the sealing cone (50). During the injection, the nozzle front end (2) is lowered toward the mold down to a predetermined position, and the cone front end (52) of the sealing cone (50) abuts against the inner diameter pin (4) of the mold, lifting the sealing cone (50) inside the nozzle, as shown in FIG. 10. By lifting the sealing cone (50), the molten resin (23) is filled in through resin flow grooves (53) that have been carved at several locations into the outer circumferential portion of the cone. While the filled resin (23) maintains its molten state, it becomes close to the ultimate cavity shape, due to the nozzle front end (2) and the moving mold (3), so that it is possible to attain better flatness and shape precision in the pressing step.

The moving mold (3) into which the molten resin has been filled is moved to the heating plate (9) in the pressing-cooling step B. In the pressing step, at least one kind of mold forming a cavity with the moving mold is mounted to a press piston (26). As shown in FIG. 5, in the present embodiment, a stamper into which pre-grooves serving as tiny information units are carved is arranged on a press mold (24), but the configuration of the mold can be chosen as suitable for the form of the product. Moreover, the material of the stamper can be chosen as suitable, and besides metal, it is also possible to use quartz glass or the like. The temperature of the press mold (24) is regulated directly or indirectly by any suitable method, and in the present embodiment, it is directly temperature-regulated by a temperature regulation circuit through which cooling water flows.

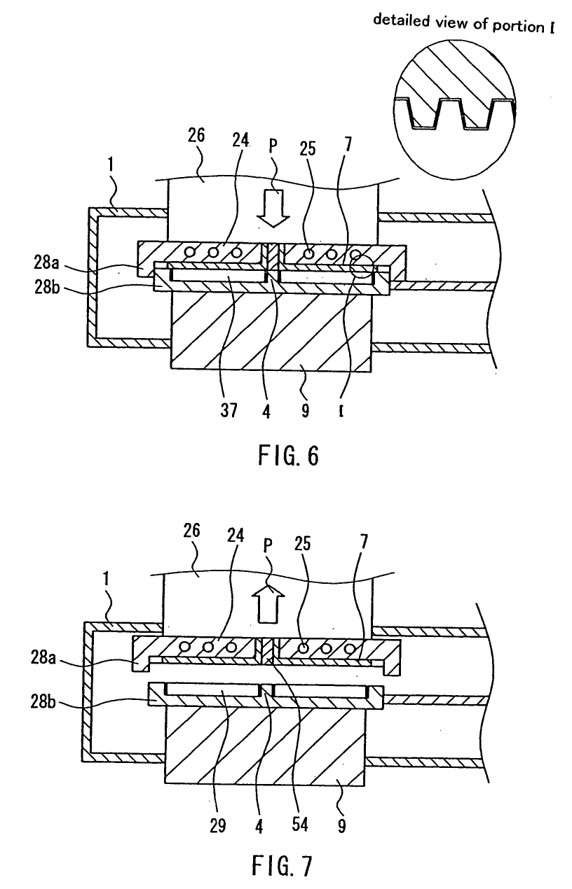

As shown in FIG. 6, the press mold (24) is clamped against the moving mold (3) through a force P of the press piston (26), forming a cavity (37). In other embodiments of the present invention, quality and mass-production efficiency can be improved by making the press mold (24) and the press piston (26) independent, while at the same time providing a plurality of pressing steps and changing the temperature regulation at each pressing step. For example, the cooling time can be shortened by making the press mold thin to improve the heat exchange effectiveness for the press mold like for the moving molds, setting the press mold and the press piston to a high temperature during the initial pressing, lowering the temperature of the press piston after the transfer, and bringing it again in close contact with the press mold to quickly cool down the press mold. In this case, a plurality of both press molds and moving molds becomes necessary. The method for centering the moving mold (3) and the press piston (26) can be chosen as suitable, and in the present embodiment, it is accomplished by fitting donut-shaped guide rings (28a) and (28b) into one another.

After the mold pressing, the press mold (24) is opened as shown in FIG. 7. After that, the product (29) and the moving mold (3) are moved to the retrieving step C. The method for retrieving the product can be chosen as suitable, and in the present embodiment, after the retrieving mechanism (14) and a suction disk (14A) attached to the same have been brought into close contact with the molded product (29), the vacuum degree inside the retrieving mechanism (14) is increased above the vacuum degree inside the vacuum furnace (1), and the molded product (29) is moved into the small vacuum furnace (17), as shown in FIG. 8. After that, while the shutter (16), which separates the small vacuum furnace (17) from the atmosphere, is momentarily opened, the retrieving mechanism (15) advances into the small vacuum furnace (17), accepts the molded product (29) from the retrieving mechanism (14), and retrieves it into the atmosphere.

The following is a more detailed explanation of the present invention by way of working examples. However, it should be noted that the present invention is not limited to these working examples.

### WORKING EXAMPLE 1

Using the injection molding apparatus according to the present invention as shown in FIGS. 2 to 8, a disk-shaped optical disk substrate with an inner diameter of φ8 mm, an outer diameter of φ50 mm, and a thickness of 0.4 mm was fabricated. On the stamper (7), a spiral-shaped pre-groove was formed with a track pitch of 0.5 μm, a groove width of 0.25 μm, and a groove depth of 70 nm, from an inner diameter of φ12 mm to an outer diameter of φ48 mm.

It is preferable that the thickness H of the moving mold (3) in FIG. 2 is not greater than 15 mm, and in this working example, it was set to 10 mm. It is preferable that the thermal conductivity of the mold is at least 20 w/m•k (at 200° C.), and in this working example an HPM 38 by Hitachi Metals Ltd. with 21.5 w/m•k (at 200° C.) was used. The vacuum degree inside the vacuum furnace (1) is preferably set to a range at which it can be prevented that air is taken in from the surface of the molten resin and bubbles are formed, and prevented that materials with a low boiling point are volatilized from inside the resin and form bubbles, and a range of 1×10⁻² to 1×10³ Pa is preferable. In the present embodiment, a vacuum degree of 0.1 Pa to 1 Pa was maintained with a rotary pump and a mechanical booster pump. The filled molten resin can be chosen as suitable, and here, AD5503 by Teijin Chemicals Ltd. (glass transition temperature (Tg): 143° C.), which is a polycarbonate resin with bisphenol A monomers was used. The heating temperature of the heater in the plasticization device (10) can be chosen as suitable, and in this working example, it was regulated to up to 300° C., and to 260° C. in the nozzle front portion (2) using band heaters. The temperature of the heating plate (8) in the injection step was set to 250° C. The surface temperature of the moving mold (3) immediately before the filling was 150° C.

The shape of the nozzle front end was as shown in FIGS. 2 to 4, and the discharge opening was ring-shaped and designed such that the injected resin spreads in donut-shape. After the plasticization measurement while the nozzle front end (17) was shut by the mechanical shutter (5) as shown in FIG. 3, the shutter was opened as shown in FIG. 4, and the screw (21) was advanced and filling was performed in a filling time of 0.1 sec. The filling amount was optimized with regard to the final product shape in accordance with the pressing step. After that, as shown in FIG. 5, the moving mold (3) was moved onto the heating stage (9) below the press mold (24) to which the above-described stamper (7) made of Ni is attached. The stamper (7) may be attached by any suitable method, and in the present embodiment, it is attached from the inside and the outside by an air vacuum not shown in the drawings. The heating stage (9) is controlled to 40° C. by cooling water not shown in the drawings.

The press mold (24) is connected to the press piston (26), and provided with a temperature regulation circuit (25) through which cooling water flows. The mold material and thickness can be chosen as suitable. Here an HPM 38 by Hitachi Metals Ltd. was used, whose thickness from the position where it is attached to the press piston to the stamper was set to 20 mm. The distance from the stamper setting surface to the cooling temperature-regulation circuit was set to 10 mm. The source of the driving force for the press piston can be chosen as suitable, and a hydraulic cylinder, an electric motor, an air cylinder or the like may be used. In this working example an air cylinder was used. Moreover, the cooling water (25) of the press mold (24) was regulated to 100° C.

Pressing was carried out as shown in FIG. 6, and centering of the mold was accomplished by fitting the outer ring (28b) of the moving mold, which defines the outer diameter of the product, against the outer ring (28a) of the pressing mold (24). The clearance between the two outer rings was adjusted such that the optimal centering precision can be attained in consideration of temperature differences, that is, differences in thermal expansion during the pressing. The pressing force P and the pressing time can be chosen as suitable, and in this working example a pressing force of 800 kgf was applied for 2 sec. The pressing causes the molten resin to be filled all the way to the edge of the cavity, and to be transferred up to the outer circumference, as shown in the detailed view of portion I.

After the transfer, by lifting the press piston (26) and the press mold (24) as shown in FIG. 7, the stamper (7) and the product (29) are separated. The mold release method for the stamper (7) and the product (29) can be chosen as suitable, and in the present embodiment, mold release was achieved within 0.3 sec by a flow of nitrogen, which is an inert gas, for 0.1 sec at a flow amount of 5 l/min from ring-shaped slits provided at an inner circumferential portion of the stamper. A gas take-in port may be provided at the outer circumferential portion, and the gas may be cooled. The method for retrieving the product (29) from the injection molding apparatus can be chosen as suitable, and in this working example it was performed as follows.

First, the moving mold (3) is moved to the retrieving step, and the molded product (29) was released from the moving mold (3) with the suction disk (14A) of the retrieving mechanism (14), and moved to the small vacuum furnace (17), as shown in FIG. 8. The vacuum degree in the small furnace (17) can be chosen as suitable, as long it does not adversely affect the vacuum degree in the filling step and the pressing step, and in this working example it was regulated to 10 to 50 Pa. After that, the shutter (16) was momentarily opened and at the same time, the retrieving mechanism (15) and the suction disk (15A) enter the vacuum furnace (17), and accepted the molded product (29) from the retrieving mechanism (14). Then, they were retracted into the atmosphere, taking out the product from the vacuum furnace (17). In this working example, the opening time of the shutter was set to 0.5 sec.

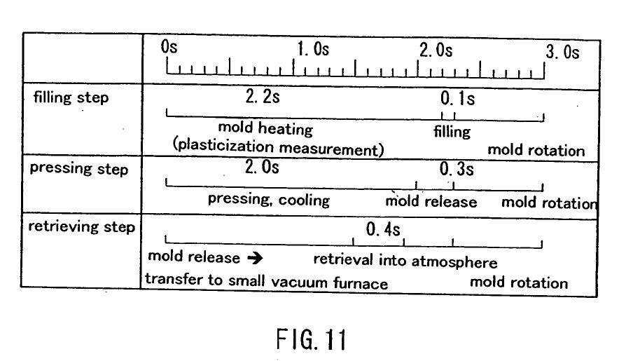

FIG. 11 shows a time chart of all steps. As shown in FIG. 11, a high cycling rate can be achieved by adjusting all the steps and performing heating, cooling and heat exchange with high efficiency.

When the transferability at the outermost circumference of an optical disk substrate fabricated with this working example was measured by AFM, it was found that the groove depth of the stamper was transferred for 99%, and also the shape maintained high symmetry, as shown in the detailed view of portion II. Imperfections such as air bubbles and flow marks in the substrate could not be observed. Moreover, when measuring the eccentricity of the groove's outer diameter with respect to the inner diameter with a toolmaker's microscope, it was found that it was 10 μm (P—P) and a substrate with low eccentricity had been fabricated. The thickness variations across the entire surface, which were measured with a micrometer, were within 2 μm, and no ski-jumps were formed at the outer diameter.

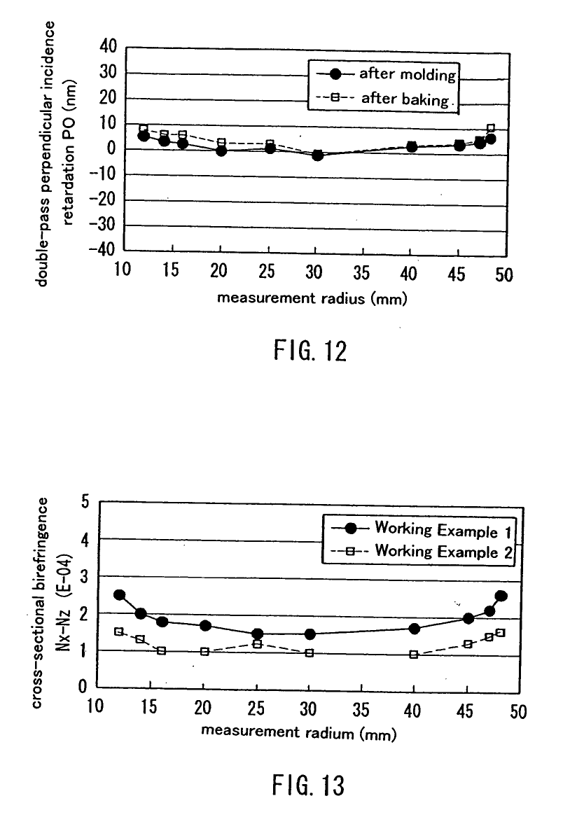

Then, the retardation (birefringence) of the substrate was measured using the birefringence evaluation apparatus F3DP-1 by Admon Science, Inc. The measurement results for double-pass retardation are shown in FIG. 12. It can be seen that it is within 10 nm across the entire surface, and almost no birefringence occurred. Here, “retardation” means the optical phase difference, which is an indicator for detecting/quantifying the extent of the birefringence. The retardation (R) is given by R=(N₁−N₂)•t, wherein N₁ is the principal refractive index in the radial direction within the disk plane, N₂ is the principal refractive index in the circumferential direction within the disk plane, and t is the thickness of the substrate. Moreover, the birefringence is given by the principal stress difference (N₁−N₂) of radial direction and circumferential direction within the disk plane.

As has been discussed in detail in a patent application by the inventors (JP 2001-243656A), with conventional molding methods, it is difficult to reduce the birefringence near the inner diameter of a substrate for thin optical disks with a thickness of for example less than 0.6 mm, and an increase in birefringence at the inner circumferential portion after changing to a high-temperature environment could not be avoided. However, it was found that with the present invention, the retardation after 4 hr of baking the product at a high temperature of 80° C. hardly changed at all, as shown in FIG. 12.

Moreover, the results of measuring in a substrate of the present invention the cross-sectional (perpendicular) birefringence (Nx−Nz), which correlates with the residual stress, are shown in FIG. 13. This cross-sectional birefringence is the difference between the principal refractive index Nx (N₁ or N₂) within the disk plane, and the principal refractive index Nz in thickness direction. (N₁−Nz) and (N₂−Nz) were calculated from the following equations (1), (2) and (3) which were published in the Japanese Journal of Polymer Science and Technology, Vol. 47, No. 6 (1990), and the larger one was taken as the cross-sectional birefringence.

N₁−Nz=1/tsin²θ₁(R_{O}−R_{θ}cos θ₁) (1)

N₂−Nz=1/tsin²θ₁(R_{O}cos²θ₁−R_{θ}cosθ₁) (2)

sin θ=n sin θ₁ (3)

In these equations, t is the substrate thickness, R_{O} is the perpendicular incident retardation, R_{θ} is the measured retardation at a constant angle θ, and n is the refractive index of 1.58. In this working example, the measurement was carried out with θ=30°.

As shown in FIG. 13, with the present invention an Nx−Nz of 2×10⁻⁴ was achieved, which is a value that was impossible to achieve with conventional molding methods. Moreover, this value is the same as for a resin material with a small photoelastic constant C. From this result, it was found that the residual stress in substrates according to the present invention is remarkably small.

### WORKING EXAMPLE 2

The same injection molding apparatus as in Working Example 1 was used, with the exception that the shape of the nozzle front end (2) in the injection step was changed to the shape shown in FIG. 9, and injection molding was carried out by the same method. The temperature of the heater (20) in the nozzle front end was regulated to 250° C. The temperature of the heating plate (8) was set to 250° C., the nozzle was moved in arrow direction in FIG. 10, and the sealing cone front end (52) of the sealing cone (50) was brought into contact with the inner diameter pin (4) of the moving mold (3), so that the sealing cone (50) inside the nozzle was pushed up, and the molten resin (23) was filled onto the mold through resin flow grooves (53) in the outer circumferential portion of the sealing cone (50). It was confirmed that in this situation, the flowing resin (23) that was filled onto the moving mold (3) was close to the final shape of the product, and also that the transfer surface (54) of the stamper maintained its flatness.

After that, pressing and product retrieval were performed in the same manner as in Working Example 1. Since a certain shape precision already has been accomplished prior to the pressing, the pressing force P in FIG. 6 was set to 400 kgf, which is lower than in Working Example 1.

The appearance, shape, and transferability of the substrate in this working example were similarly good as in Working Example 1. Moreover, the measurement results of the cross-sectional birefringence are shown in FIG. 13 together with those of Working Example 1, and the internal residual stress has been reduced even more than in Working Example 1. This seems to be due to the reduction of stress occurring during the pressing.

### COMPARATIVE EXAMPLE 1

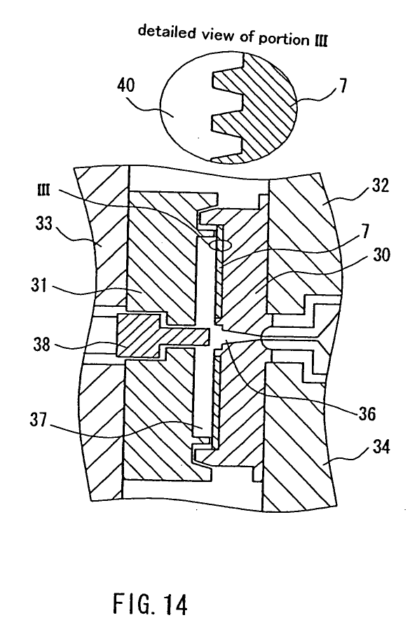

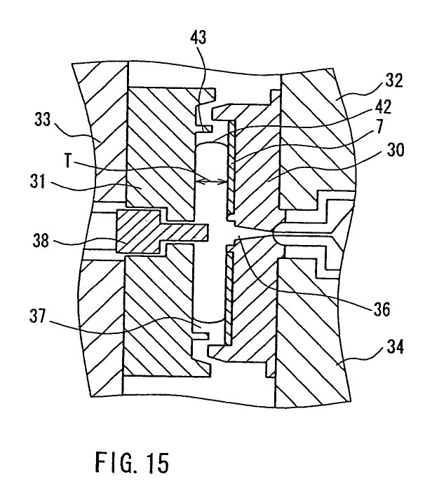

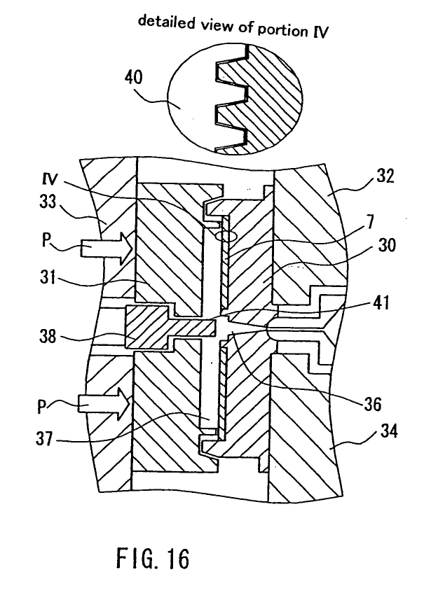

An optical disk using the same resin as in Working Example 1 was fabricated using the conventional molding method shown in FIGS. 14 to 17. As the injection molding apparatus, an SD 35E by Sumitomo Heavy Industries, Ltd. was used. The temperature of the temperature-regulation circuit of the fixed mold (30) and the movable mold (31) was set to 120° C. for both, and a temperature-regulating circuit for the cut punch (38) and the spool (36) was not provided. The cavity opening amount T during filling as shown in FIG. 15 was set to 0.8 mm, which is 0.4 mm thicker than the final product thickness t=0.4 mm. The temperature of the filled resin (temperature of the cylinder heating tube) was set to up to 380° C., and the filling time was set to 0.04 sec. FIG. 18 shows a time chart for plasticization and clamping. Immediately after the filling, a clamping pressure of 15 ton was applied for 0.2 sec, and the cut punch (38) was driven in at the same time as the compression transfer as shown in FIG. 16, thus punching out the inner diameter. Then, after the clamping pressure had been reduced to 8 tons and held for 2.9 sec, the mold was opened and the product was retrieved within 0.4 sec.

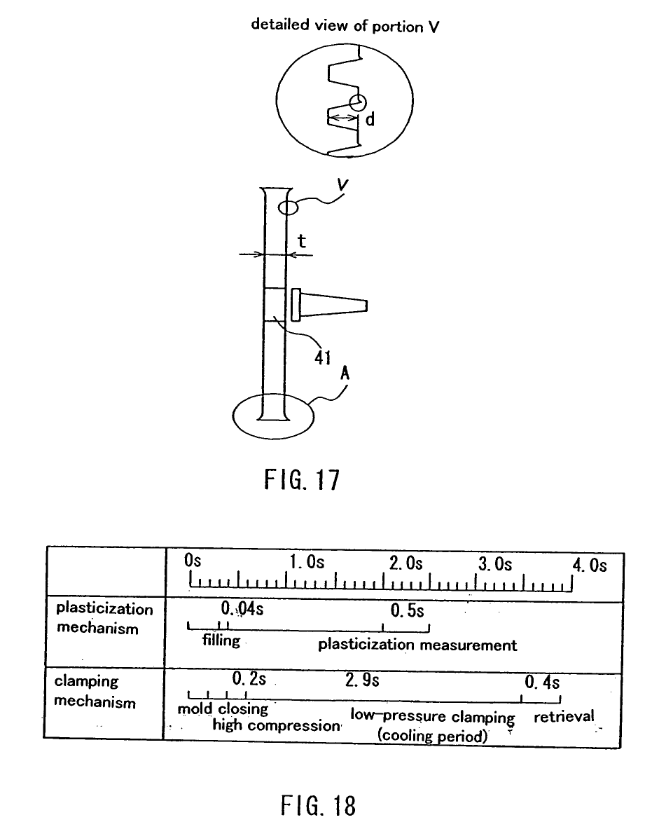

The transferability of the substrate in this comparative example was measured by AFM. As a result, the transfer ratio of the groove depths was 98%, but slight deformations as shown in the detailed view of portion III of FIG. 17 could be observed. Moreover, the eccentricity of the signal outer diameter to the substrate's inner diameter was 30 μm (P—P). When measuring the substrate thickness, it was found that there were variations of 5 μm up to a diameter φ48 mm at 2 mm inwards of the outer diameter φ50 mm of the product, but further outward, the substrate became locally another 7 μm thicker, and there were ski-jumps as shown in portion A of FIG. 17.

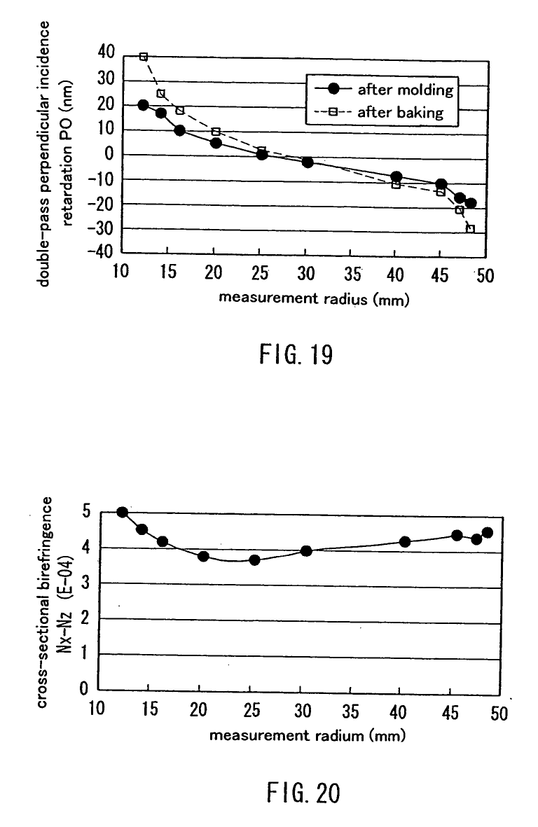

Next, the perpendicular incident retardation and the cross-sectional birefringence of the optical disk substrate according to this comparative example were measured in the same manner as in the working examples. The results are shown in FIGS. 19 and 20. FIG. 19 shows that the perpendicular incident retardation after the molding was controlled to 20 nm after the molding and was good, but the shift amount due to baking was large. Moreover, FIG. 20 shows that the cross-sectional birefringence was much larger than the value attained with the present invention.

It should be noted that with the above-mentioned patent application of the inventors, the retardation after the baking can be controlled to about ±30 nm with such a method as reducing a viscosity difference, using such means as changing the cooling efficiency at the inner and outer circumference with the temperature-regulating circuit of the mold, but the dependency of the cross-sectional birefringence on the properties of the used resin is large, so that a reduction below 4.0×10⁻⁴ was difficult.

### WORKING EXAMPLE 3

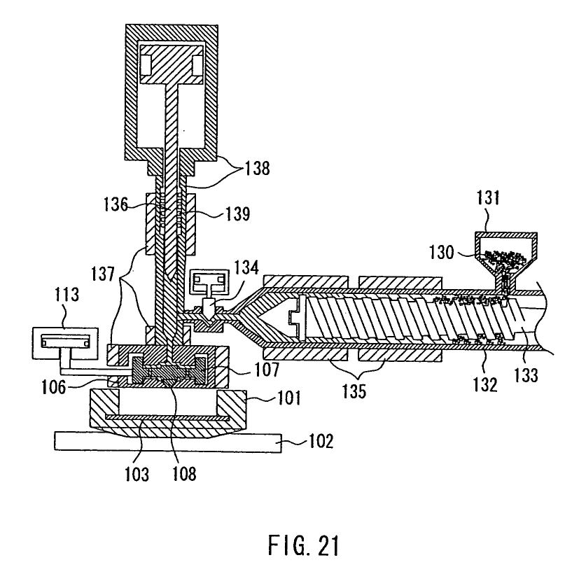

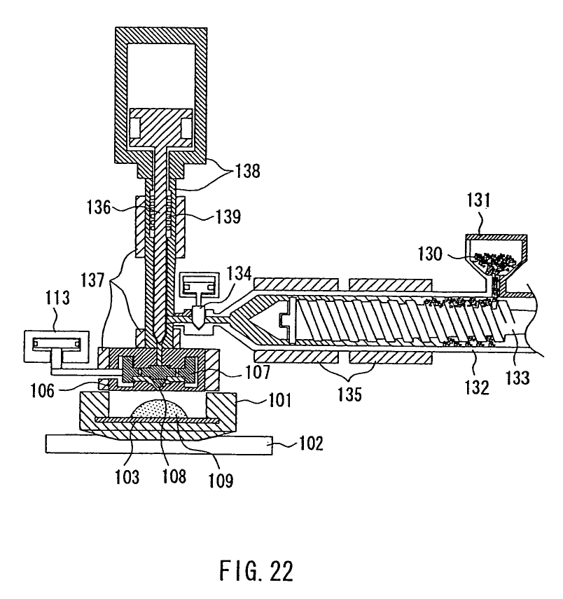

FIGS. 21 to 26 are schematic diagrams of a molding method, in which a polycarbonate with a glass transition temperature of 140° C. was used as the thermoplastic resin material, and a supercritical fluid of CO₂ gas was included. FIGS. 21 and 22 show the step of filling the molten resin, and a moving mold (101) on which a stamper (103) provided with a fine structure is arranged is placed on a moving table (102), and the moving mold (101) is moved to the various steps together with the table.

As shown in FIG. 28, in the fine structure in the stamper (103), a line-and-space structure with a high aspect ratio in which a pattern of depressions with a depth D of 0.6 μm and a width W of 0.15 μm (and thus an aspect ratio of 4) are formed with Ni one after the other at a spacing of 0.2 μm, and the inner wall of the moving mold was formed into a disk-shaped cavity of φ50 mm.

This moving mold was heated to at least the glass transition temperature Tg of the thermoplastic resin. For the heating method, any suitable direct or indirect heating method may be chosen, such as ultrasonic/inductive heating, transfer heating, heating with a temperature-adjusted solvent, a halogen lamp or the like. In the present working example, the mold was placed in close contact onto a hot plate that was pre-heated to 500° C., and at the same time irradiated with a halogen lamp, and the surface temperature of the moving mold (101) and the stamper (103) was regulated to 200° C. before the filling of the resin.

The thermoplastic resin was given in form of pellets (130) from a hopper (131) into a plasticizing cylinder (132), and plasticized by rotating a screw (133). It is preferable that the pellets (130) are sufficiently degassed prior to plasticization, and in addition to drying and degassing them in a drying device not shown in the drawings prior to giving them into the hopper (131), they were evacuated during closed vessel heating in the hopper (131). By sufficiently drying the resin and eliminating oxygen, it is possible to suppress bubbles which occur easily during injection and hydrolysis due to retention in the sealing mechanism (134), even when using a resin material with a large water absorption coefficient. It is also possible to mix or permeate a supercritical fluid through the plasticized and molten resin, but when the mold is opened, this fluid escapes from the resin and the efficiency is poor, so that in this working example, the supercritical fluid was permeated while the cavity was closed in the transfer step.

The injection apparatus of this working example is of the pre-plasticizing type, and during the plasticization, the pellets (130) that are fed from the hopper (131) are plasticized by rotating the screw (133) inside the plasticizing cylinder (132) around which heat-controlled band heaters (135) are wound while the sealing mechanism (134) is open as shown in FIG. 21, passed through the sealing mechanism (134), and filled before the injection plunger (136). The injection plunger (136) is guided by a ball retainer (139) at the inner wall of the injection cylinder (138), and allows for smooth driving with a narrow clearance but without cutting into the injection cylinder. The injection cylinder (138) and the nozzle (106) coupled to its front end are heated by band heaters (137), and a gate (108) is closed by a valve (107) that is controlled by a cylinder (113) mechanism, such that the molten resin does not leak from the nozzle (106) during the plasticization of the resin. In this working example, the band heaters (135) of the plasticization cylinder (132) were regulated to 350° C. and the band heaters (137) of the injection cylinder (138) and the nozzle (106) were regulated to 370° C.

During the injection, the gate (108) at the surface of the nozzle (106) is opened by driving the valve (107) that is linked to the cylinder mechanism (113), and the injection plunger (136) is advanced by, for example, hydraulic pressure inside the injection cylinder (138), so that the plasticized molten resin (109) is filled onto the surface of the stamper (103) inside the moving mold (101), as shown in FIG. 22. In the present invention, the moving mold (101) before the filling is heated to at least the glass transition temperature of the thermoplastic resin, so that even with a low injection filling pressure, the molten resin will not contact the mold surface and solidify, or form a skin layer at its surface. For this reason, the birefringence of the molded product becomes low, and viscosity increases due to temperature decreases can be suppressed. It should be noted that the atmosphere inside the mold during the injection may be chosen as suitable, but bubbles are formed at the molten resin surface when oxygen from the atmosphere is taken in, so that it is preferable that the vacuum degree is in a range of 1×10⁻² to 1×10³ Pa, in order to suppress the generation of bubbles, or it may also be an inert gas atmosphere of carbon dioxide.

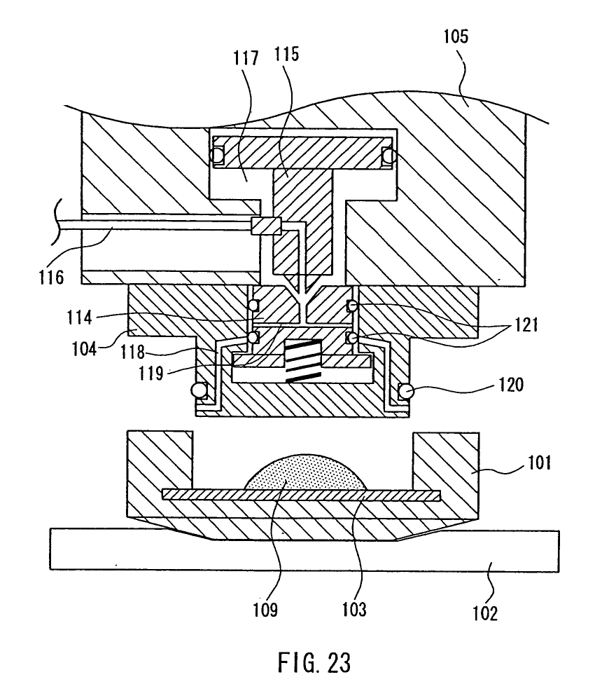

In this working example, the moving mold (101) into which the molten resin (109) has been filled was immediately moved from the injection step to the pressing step together with the moving table (102). FIGS. 23 to 26 show diagrammatic views of the molding method in the pressing step. First, as shown in FIG. 23, a press mold (104), which is fastened to the clamping apparatus (105) and heated to a certain temperature was inserted. In the present invention, the method for controlling the temperature of the press mold (104) and the temperature settings can be chosen as suitable, and in this working example, at the beginning of the pressing a temperature-regulation circuit through which cooling water (not shown in the drawings) using water as the medium flows regulates the temperature to 145° C., which is slightly higher than the glass transition temperature, and lowers it to 100° C. during the pressing.

Inside the clamping apparatus (105) of this working example, a supercritical fluid spouting piston (115) accommodated inside an air cylinder (117) is arranged such that at can be moved up and down, and this piston (115) is connected with a linking hose (116) to a supercritical fluid generation device (not shown in the drawings). A supercritical fluid is spouted by opening an electromagnetic valve (not shown in the drawings). Also, an internal core (114) for introducing the supercritical fluid is provided inside the press mold (104). The supercritical flow paths (118) and (119) in the press mold (104) can be linked and disconnected by raising and lowering this core. Moreover, the supercritical fluid is completely sealed with O-rings (120) and (121), which prevent leakage from the mold when the mold is closed, such that it can rapidly permeate into the resin, whose specific volume has been enlarged and whose intermolecular distance extended since it is in the molten state.

In the present invention, at least at the transfer surface, the resin surface and the mold surface need to be maintained at the glass transition temperature or higher, until pressure is exerted on the mold and a fine structure, such as that of the stamper (103) is transferred, and after the transfer has finished, they need to be lowered below the glass transition temperature. In the present invention, the moving mold (101) and the moving table (102) are in close contact with a cooling plate not shown in the drawings. The cooling plate's temperature is regulated by temperature-regulating water of 100° C. The moving table (102), with has a certain heat capacity, and the moving mold (101) have heat taken away from the cooling plate, so that their temperature gradually degreases, and it was ensured that in about 40 sec, the temperature of the surface of the moving mold (101) and the stamper (103) is not greater than 140° C., which is the glass transition temperature of the resin material, and the transfer was terminated until then.

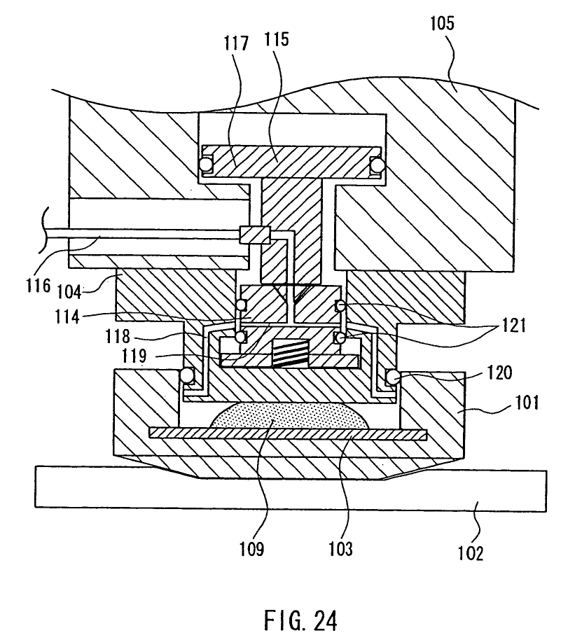

In this working example, the introduction of the supercritical fluid into the mold was performed as shown in FIG. 24. That is to say, the clamping apparatus (105) was driven by hydraulic power (not shown in the drawings), and when the press mold (104) fastened to it and the O-ring (120) provided around the same enter the moving mold (101), the supercritical fluid spouting piston (115) incorporated into the air cylinder (117) advances, and by pressing down the inner core (114) inside the mold, the fluid paths (118) and (119) are connected inside the O-ring (120). Then, by opening an electromagnetic valve (not shown in the drawings), the supercritical fluid is filled into the closed mold from a supercritical fluid generation apparatus (not shown in the drawings) through a coupling hose (116) and the fluid paths (118) and (119) inside the mold. Carbon dioxide (CO₂) was used as the supercritical fluid. The conditions at which carbon dioxide assumes the supercritical state are a temperature of 31.1° C. and a pressure of 75.2 kgf/cm², and in this working example, it was turned supercritical at a temperature of 150° C. and a pressure of 200 kgf/cm². It is also possible to turn the carbon dioxide into a supercritical fluid by first filling highly concentrated carbon dioxide together with the molten resin into the closed mold, and then performing the clamping transfer at conditions above the supercritical temperature and pressure of the carbon dioxide.

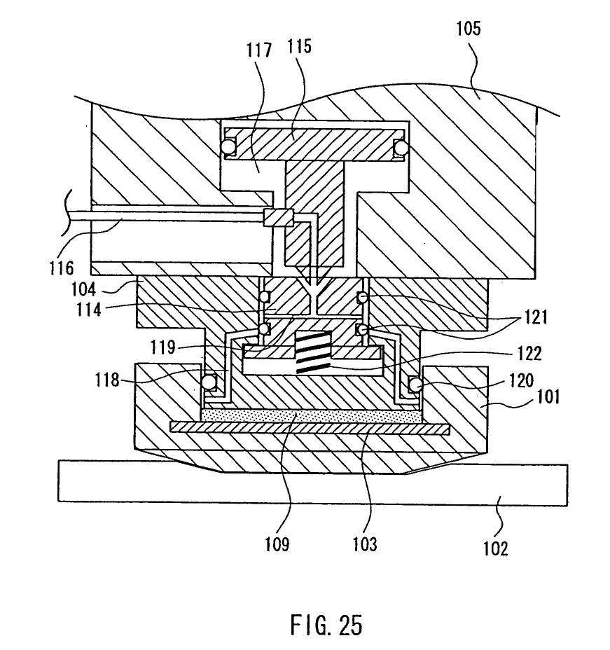

After a predetermined amount of supercritical fluid has been filled into the mold, the supercritical fluid spouting piston (115) is retracted, and the inner core (114) is retracted by the force of the return spring (122), as shown in FIG. 25, thereby disconnecting the fluid paths (118) and (119). Then, a pressure is applied on the cavity between the press mold (104) and the moving mold (101) by letting the clamping apparatus (105) apply the clamping force, and the fine structure on the stamper (103) is transferred onto the thermoplastic resin material (109). In this situation, the clamping force may be chosen as suitable, and in the present invention, since it is necessary to sustain the supercritical state of the fluid at least until the transfer has been finished and the resin has been hardened, after a clamping force of 10 tons (a pressure of 509 kgf/cm²) has been applied for 3 sec, the clamping force is reduced to 5 tons (a pressure of 255 kgf/cm²) to cool and solidify the resin.

The supercritical fluid that has permeated into the resin can be adjusted by letting it escape to the outside during the solidifying or hardening. When a lot of the supercritical fluid remains inside the resin, then it becomes difficult to suppress bubbles during the gasification when removing the pressure. In this working example, the supercritical fluid spouting piston (115) is advanced during the cooling for 1 sec while maintaining the clamping pressure, and excess supercritical fluid and volatilized gas inside the resin is caused to escape out of the mold.

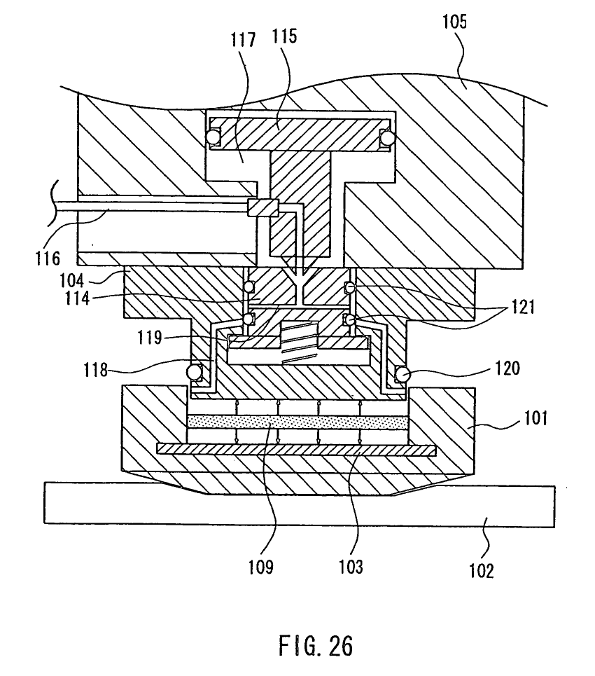

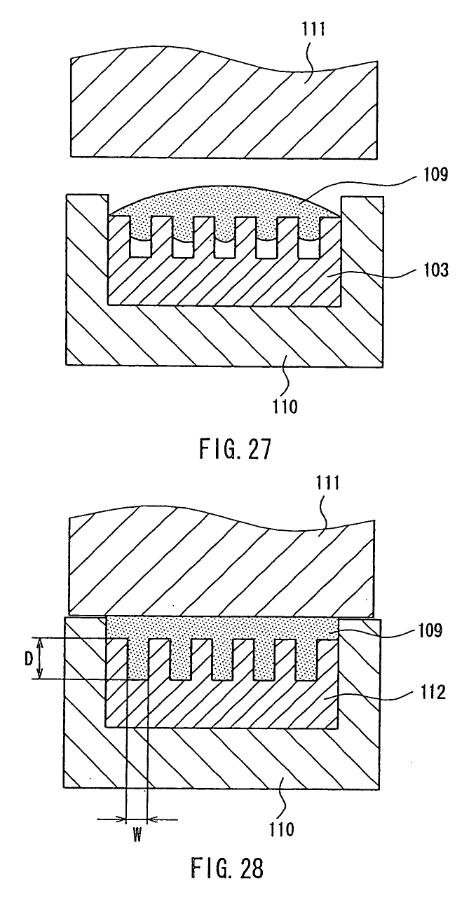

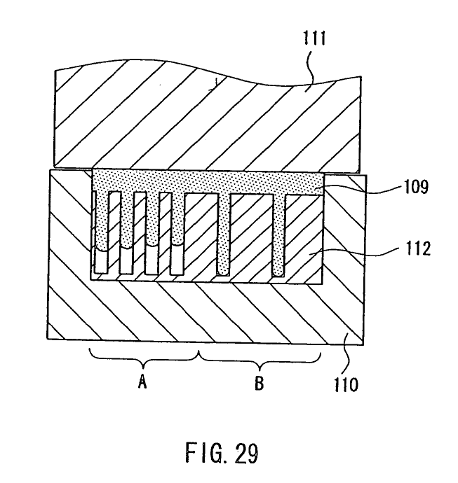

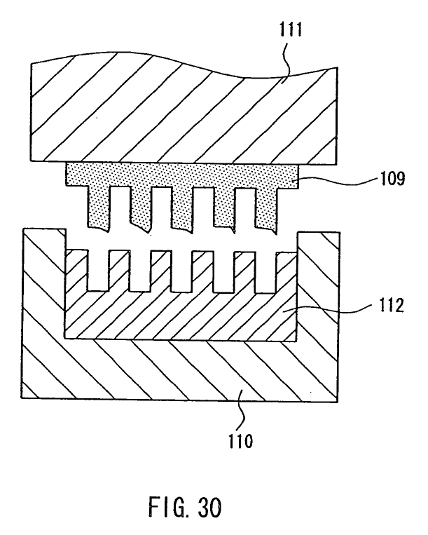

After that, the clamping force was released, and the mold was opened, as shown in FIG. 26. At the same time as the pressure is released, the supercritical fluid cannot maintain its supercritical state, so that it gasifies and attempts to expand to a large volume, but the resin material has solidified and the intermolecular distance is difficult to move, so that the volatilized gas attempts to escape from the resin surface towards the molds, as indicated by the arrow in FIG. 26. Utilizing this pressure, the replica (109) of the resin that closely adheres to the fine structure can be easily separated therefrom.

The moving mold (101) and the resin material (109) that has been separated from the mold surface are moved to the next step, and a retrieval robot (not shown in the drawings) retrieves the product, whereafter only the moving mold (101) is returned to the heating step. By moving a plurality of moving molds (101) through the steps, replicas of a structure with high aspect ratio can be manufactured continuously.

The resin replica in this working example was ruptured by liquid nitrogen and its cross-sectional shape was measured by SEM, it was found that the line-and-space structure, including the edge shape, had been accurately transferred.

### INDUSTRIAL APPLICABILITY

As explained in the foregoing, with the injection molding method of the present invention, precise transferability and mechanical characteristics are achieved that allow accurate transfer of superfine structures for which a satisfactory transfer could not be accomplished with conventional molding methods, and moreover, the production efficiency can be improved, allowing the mass production of replica, for example. Moreover, the molded products obtained with the molding method of the present invention have little retardation, are uniform, have a small cross-sectional birefringence and superior optical characteristics.

1. (amended) A molding method for obtaining a molded product, wherein a molten resin is filled from a plasticization apparatus through a nozzle into a mold that forms a cavity and that is constituted by at least two members, wherein at least one member constituting the mold is moved through stages that are divided into at least three steps including a filling step, a pressing step and a molded product retrieving step, and wherein in the filling step, pressure is applied to the molten resin in the plasticization apparatus and the molten resin is filled into the cavity, which is not closed, of said one member, and then the molded product is formed in the pressing step.

2. The molding method according to claim 1, wherein the molten resin is filled within a vacuum into the cavity, which is not closed.

3. The molding method according to claim 1, wherein the molded product is formed by solidifying the molten resin after a supercritical fluid of CO₂ gas has been permeated under pressure into the molten resin that has been filled into the cavity.

4. The molding method according to claim 3, wherein after the thermoplastic resin has solidified, the supercritical fluid is gasified by releasing the mold pressure, and a solidified product of thermoplastic resin is released from the mold by this gas pressure.

5. The molding method according to claim 1, wherein said one member moves onto a stage that has been heated in the injection step to at least (Tg−20)° C., wherein Tg is the glass transition temperature of the used resin material, and moves onto a stage that has been heated to not more than (Tg+100)° C. in the pressing step.

6. The molding method according to claim 1, wherein when filling the thermoplastic resin into the mold and at the start of pressing, the mold temperature is set to at least the glass transition temperature of the thermoplastic resin, and during the pressing, the mold temperature is made lower than that glass transition temperature to cause solidification.

7. (amended) The molding method according to claim 1, wherein the molten resin is filled into the mold after the resin has been plasticized/measured inside the plasticization apparatus.

8. (amended) The molding method according to claim 7, wherein the nozzle is provided with a resin leakage suppressing mechanism, and while plasticizing/mlasuring the resin inside the plasticization apparatus, the nozzle is closed by the resin leakage suppressing mechanism, and after the measurement has finished, the nozzle is opened and the molten resin is filled into the mold.

9. (new) A molding method for obtaining a molded product, wherein a molten resin is filled from a plasticization apparatus through a nozzle into a mold that forms a cavity and that is constituted by at least two members;
wherein at least one member constituting the mold is moved through stages that are divided into at least three steps including a filling step, a pressing step and a molded product retrieving step;
wherein, after the resin has been plasticized/measured inside the plasticization apparatus, in the filling step, pressure is applied to the molten resin in the plasticization apparatus and the molten resin is filled into the cavity, which is not closed, of said one member, and then the molded product is formed in the pressing step; and
wherein the nozzle is provided with a resin leakage suppressing mechanism, and while plasticizing/mlasuring the resin inside the plasticization apparatus, the nozzle is closed by the resin leakage suppressing mechanism, and after the measurement has finished, the nozzle is opened and the molten resin is filled into the mold.
